(19) United States
(12) Patent Application Publication
(10) Pub. No.: US 2015/0276020 A1
(43) Pub. Date: Oct. 1, 2015

(54) TWO SPEED TRANSMISSION

(71) Applicant: SPG Co., Ltd., Incheon (KR)

(72) Inventors: Jin Gyun YOON, Suwon-si (KR); Ju Yong CHOI, Bucheon-si (KR)

(73) Assignee: SPG CO., LTD., Incheon (KR)

(21) Appl. No.: 14/516,113

(22) Filed: Oct. 16, 2014

(30) Foreign Application Priority Data
Mar. 26, 2014 (KR) 10-2014-0035372

(51) Int. Cl. F16H 3/00; F16H 61/16

(52) U.S. Cl. CPC F16H 3/005; F16H 61/16; F16H 2200/0034; F16H 2200/2005; F16H 2200/2084; F16H 2061/166

(57) ABSTRACT

A two-speed transmission including: a sun gear configured to be rotated by an external driving force; a planet gear arranged around the sun gear; a ring gear having a gear train; a first clutch configured to be engaged with the sun gear to be restrained by the sun gear if the sun gear is rotated in a first direction; a second clutch configured to be engaged with the ring gear to be restrained by the ring gear if the sun gear is rotated in a second direction; and a carrier configured to receive a driving force from the sun gear by restraint of the first clutch to be driven in a first reduction gear ratio or to receive a driving force that is transferred through the sun gear, the planet gear, and ring gear by restraint of the second clutch to be driven in a second reduction gear ratio.

### CROSS-REFERENCE TO RELATED APPLICATIONS

This application is based on and claims priority from Korean Patent Application No.10-2014-0035372, filed on Mar. 26, 2014 in the Korean Intellectual Property Office, the disclosure of which is incorporated herein in its entirety by reference.

### BACKGROUND

1. Field of the Invention

The present invention relates to a two-speed transmission, and more particularly to a two-speed transmission, which can adjust a reduction gear ratio of the two-speed transmission according to a motor operation direction, and can implement a rotation direction of an output shaft of the two-speed transmission in the same direction as the motor operation direction or implement the rotation direction of the output shaft of the two-speed transmission in a predetermined specific direction regardless of the motor operation direction.

2. Description of the Prior Art

A transmission serves to receive a rotational force that is generated from an engine or a motor that is a power generating device and to convert the received rotational force into an appropriate transmission gear ratio to transfer the converted rotational force to a driven side. Various types of transmission methods have been used, such as a gear type transmission method in which a plurality of gears are engaged with different gear ratios, a transmission method using a belt or a chain, and a continuous transmission method using an inclined rotating body, such as a cone friction wheel.

Among the transmissions as described above, the gear type transmission method using a plurality of gears may transfer a greater rotating torque and may have the most accurate transmission gear ratio. The gear type transmission method has been widely used in various industrial machineries, such as automobiles, and has recently been applied to electric automobiles, juicers, and the like.

### PRIOR ART DOCUMENT

### Patent Document

Korean Unexamined Patent Publication No. 10-2008-0049526 (Published on Jun. 4, 2008)

### SUMMARY

Accordingly, the present invention has been made to solve the above-mentioned problems occurring in the prior art, and one subject to be solved by the present invention is to provide a two-speed transmission, which can adjust a reduction gear ratio of the two-speed transmission according to a motor operation direction, and can implement a rotation direction of an output shaft of the two-speed transmission in the same direction as the motor operation direction or implement the rotation direction of the output shaft of the two-speed transmission in a predetermined specific direction regardless of the motor operation direction.

Additional advantages, subjects, and features of the invention will be set forth in part in the description which follows and in part will become apparent to those having ordinary skill in the art upon examination of the following or may be learned from practice of the invention.

In one aspect of the present invention, there is provided a two-speed transmission comprising: a sun gear configured to be rotated with an input shaft that transfers an external driving force; a planet gear portion arranged in a predetermined specific structure around the sun gear to be tooth-engaged with the sun gear; a ring gear having a gear train formed on an inner circumference thereof to be tooth-engaged with the planet gear portion; a first one-way clutch configured to be engaged with the sun gear to be restrained by the sun gear if the sun gear is rotated in a first rotating direction; a second one-way clutch configured to be engaged with the ring gear to be restrained by the ring gear if the sun gear is rotated in a second rotating direction; and a carrier configured to receive a driving force from the sun gear by restraint of the first one-way clutch to be driven in a first reduction gear ratio or to receive a driving force that is transferred through the sun gear, the planet gear portion, and the ring gear by restraint of the second one-way clutch to be driven in a second reduction gear ratio, and to be rotated with an output shaft.

Accordingly, since the present invention provides the two-speed transmission which can adjust the reduction gear ratio of the two-speed transmission according to the motor operation direction and can implement the rotation direction of the output shaft of the two-speed transmission in the same direction as the motor operation direction or implement the rotation direction of the output shaft of the two-speed transmission in the predetermined specific direction regardless of the motor operation direction, the reduction gear ratio of the two-speed transmission can be easily adjusted through the change of the motor operation direction. Further, the two-speed transmission, in which the output shaft is rotated in the same direction as the motor operation direction to match the characteristics of the device on which the two-speed transmission is mounted, can be selected and mounted on the corresponding device, or the two-speed transmission, in which the output shaft is rotated only in the predetermined specific direction regardless of the motor operation direction, can be selected and mounted on the corresponding device.

The effects of the present invention are not limited to the above-described effects, and further effects that have not been mentioned could be clearly understood by those skilled in the art from the following description.

### BRIEF DESCRIPTION OF THE DRAWINGS

The above and other objects, features and advantages of the present invention will be more apparent from the following detailed description taken in conjunction with the accompanying drawings, in which:

FIG. 1 is a front view of a two-speed transmission according to an embodiment of the present invention;

FIG. 2 is a side view of a two-speed transmission according to an embodiment of the present invention;

FIG. 3 is a cross-sectional view illustrating a cross section of a two-speed transmission of FIG. 2 in B-B direction according to an embodiment of the present invention;

FIG. 4 is a cross-sectional view illustrating a cross section of a two-speed transmission of FIG. 2 in A-A direction according to an embodiment of the present invention;

FIG. 5 is a cross-sectional view illustrating a cross section of a two-speed transmission of FIG. 2 in B-B direction according to another embodiment of the present invention; and

FIG. 6 is a cross-sectional view illustrating a cross section of a two-speed transmission of FIG. 2 in A-A direction according to another embodiment of the present invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, preferred embodiments of the present invention are described in detail with reference to the accompanying drawings.

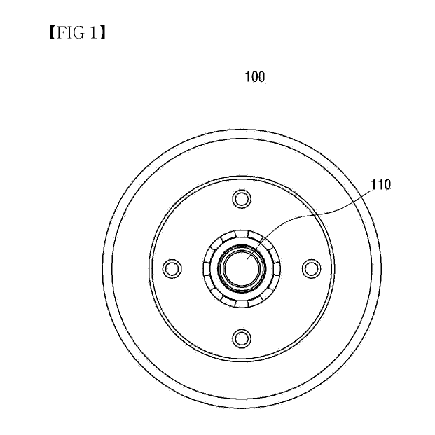

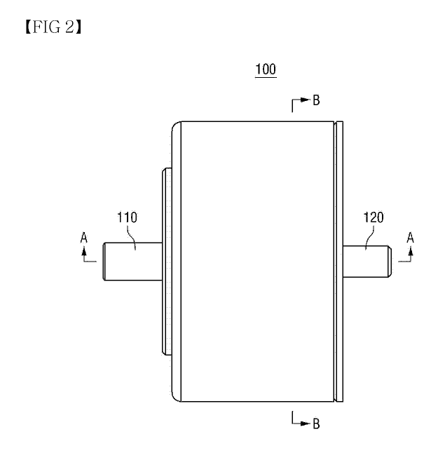

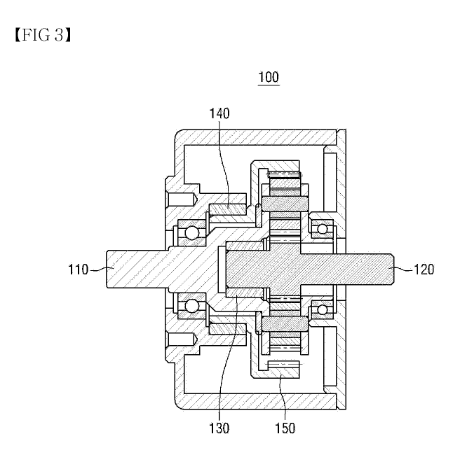

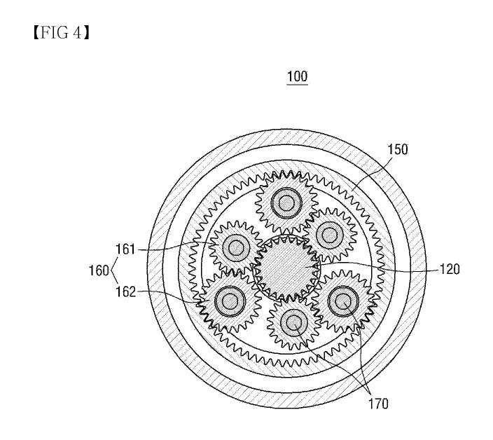

FIG. 1 is a front view of a two-speed transmission according to an embodiment of the present invention, and FIG. 2 is a side view of a two-speed transmission according to an embodiment of the present invention. FIG. 3 is a cross-sectional view illustrating a cross section of a two-speed transmission of FIG. 2 in B-B direction according to an embodiment of the present invention, and FIG. 4 is a cross-sectional view illustrating a cross section of a two-speed transmission of FIG. 2 in A-A direction according to an embodiment of the present invention.

Referring to FIGS. 1 to 4, a two-speed transmission 100 according to an embodiment of the present invention may include a structure that is configured to adjust the reduction gear ratio of the two-speed transmission 100 according to a motor operation direction and to implement the rotating direction of an output shaft of the two-speed transmission 100 in a predetermined specific direction regardless of the motor operation direction.

The two-speed transmission 100 may be configured to include a sun gear 120, a planet gear portion 160, a ring gear 150, a first one-way clutch 130, a second one-way clutch 140, and a carrier 110.

The sun gear 120 is an input gear, and may serve to directly transfer a driving force to the carrier 110 or to drive the planet gear portion 160 to be described later through transfer of an external driving force to the inside of the two-speed transmission 100. More specifically, the sun gear 120 may be connected to an input shaft to transfer the driving force of an external driving source, such as a motor that is installed in an industrial device, to the sun gear 120 through the input shaft. As the external driving force is transferred to the sun gear 120 through the input shaft, the sun gear 120 can be rotated integrally with the input shaft.

One end of the sun gear 120 may be connected to the input shaft, and the other end thereof may be inserted into a groove that is formed inside the carrier 110. Further, the sun gear 120 may be positioned on a center shaft of the two-speed transmission, and the planet gear portion 160 may be positioned around the sun gear 120.

The planet gear portion 160 may include a plurality of planet gears to receive the driving force from the sun gear 120 and then to provide an output to the carrier 110.

Further, the planet gear portion 160 may be arranged around the sun gear 120 with a predetermined specific structure. Here, the predetermined specific structure of the planet gear portion 160 may be a structure that implements the rotating direction of the output shaft of the two-speed transmission 100 in a predetermined specific direction regardless of the motor operation direction.

That is, the planet gear portion 160 may include at least one first planet gear 161 that is tooth-engaged with a gear train formed on the outer circumference of the sun gear 120, and at least one second planet gear 162 that is tooth-engaged with a gear train formed on the outer circumference of the first planet gear 161 and is tooth-engaged with a gear train formed on the inner circumference of the ring gear 150.

The first planet gear 161 serves to receive the driving force of the sun gear 120 through the structure that is tooth-engaged with the gear train formed on the outer circumference of the sun gear 120.

The second planet gear 162 can serve to designate the rotating direction of the output shaft of the two-speed transmission in the predetermined specific direction (e.g., in a clockwise direction) regardless of the driving direction of the motor that rotates the sun gear 120.

Further, the first one-way clutch 130 is configured to determine whether to transfer the driving force between the sun gear 120 and the carrier 110. When the sun gear 120 is rotated in a first rotating direction (e.g., clockwise direction), the first one-way clutch 130 is engaged with the sun gear 120 to be restrained by the sun gear 120.

That is, as the first one-way clutch 130 is restrained by the sun gear 120, it can directly transfer the driving force of the sun gear 120 to the carrier 110.

In this case, the carrier 110 directly receives the driving force of the sun gear 120 from the sun gear 120 through the first one-way clutch 130, and thus can be driven in a first reduction gear ratio. For example, the first reduction gear ratio may be 1:1.

If the first one-way clutch 130 operates as described above, the second one-way clutch 140 is configured not to operate. That is, since the second one-way clutch 140 does not operate, the planet gear portion 160 and the ring gear 150, which operate together by the driving of the sun gear 120, are idling.

In contrast, if the sun gear 120 is rotated in a second rotating direction (e.g., counterclockwise direction), the first one-way clutch 130 is not engaged with the sun gear 120 and thus is not restrained by the sun gear 120.

That is, a driving force transfer path between the sun gear 120 and the carrier 110 is blocked by the first one-way clutch 130, and the driving force of the sun gear 120 is transferred to the carrier 110 through the second one-way clutch 140.

In this case, the carrier 110 receives the driving force of the sun gear 120, which is gear-shifted through the sun gear 120, the planet gear portion 160, and the ring gear 150, through the second one-way clutch 140, and thus can be driven in a second reduction gear ratio. For example, the second reduction gear ratio may be 3.6:1.

If the second one-way clutch 140 operates as described above, the first one-way clutch 130 is configured not to operate. That is, by the operation of the second one-way clutch 140, the planet gear 160 and the ring gear 150, which operate together by the driving of the sun gear 120, transfer the gear-shifted driving force to the carrier 110 through the second one-way clutch 140.

Since the center shaft of the planet gear portion 160 is connected to one side of the carrier 110 through gear pins 170, it may be provided as a support structure that is connected to one side of the carrier 110.

On the other hand, in the device on which the two-speed transmission is mounted, a control module, which changes the rotating direction of the sun gear 120 that is provided in the two-speed transmission 100 to a predetermined specific pattern, may be included.

The control module can change the rotating direction of sun gear 120 to the predetermined specific pattern according to the load level of the motor that provides the external driving force to the sun gear 120.

For example, in the case where the load level of the motor is within a predetermined threshold range to indicate a normal speed of the motor operation, the motor may make the sun gear 120 be continuously rotated in the first rotating direction (e.g., clockwise direction) to maintain the output of the carrier 110 according to the restraint of the first one-way clutch.

AS another example, the load level of the motor may deviate from the predetermined threshold range. If the driving force of the motor is unable to reach the driving force in a normal operation state, the motor may make the sun gear 120 be rotated in the second rotating direction (e.g., counterclockwise direction) to shift the driving force to the output of the carrier 110 of which the reduction gear ratio is increased by the restraint of the second one-way clutch 140.

Further, if the load level of the motor reenters into the predetermined threshold range to indicate the normal speed of the motor operation, the control module may rotate the sun gear 120 again in the first rotating direction (e.g., clockwise direction).

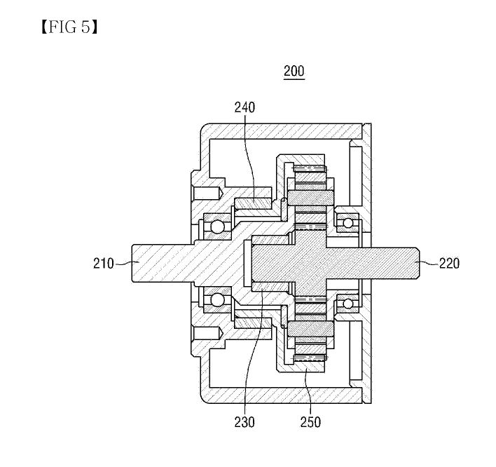

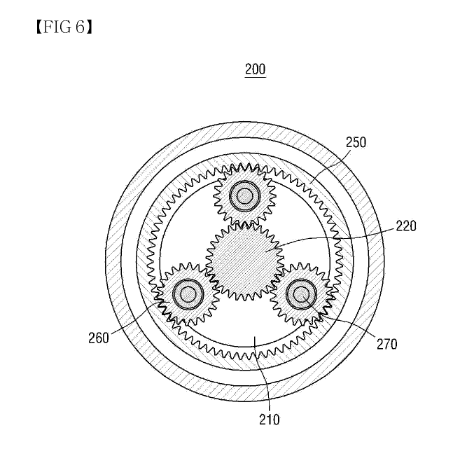

FIG. 5 is a cross-sectional view illustrating a cross section of a two-speed transmission of FIG. 2 in B-B direction according to another embodiment of the present invention, and FIG. 6 is a cross-sectional view illustrating a cross section of a two-speed transmission of FIG. 2 in A-A direction according to another embodiment of the present invention.

Referring to FIGS. 5 and 6, a two-speed transmission 200 according to another embodiment of the present invention may include a structure that is configured to adjust the reduction gear ratio of the two-speed transmission 200 according to a motor operation direction and to implement the rotating direction of an output shaft of the two-speed transmission 200 in the same direction as the motor operation direction.

The two-speed transmission 200 may be configured to include a sun gear 220, a planet gear portion 260, a ring gear 250, a first one-way clutch 230, a second one-way clutch 240, and a carrier 210.

The sun gear 220 is an input gear, and may serve to directly transfer a driving force to the carrier 210 or to drive the planet gear portion 260 to be described later through transfer of an external driving force to the inside of the two-speed transmission 200. More specifically, the sun gear 220 may be connected to an input shaft to transfer the driving force of an external driving source, such as a motor that is installed in an industrial device, to the sun gear 220 through the input shaft. As the external driving force is transferred to the sun gear 220 through the input shaft, the sun gear 220 can be rotated integrally with the input shaft.

One end of the sun gear 220 may be connected to the input shaft, and the other end thereof may be inserted into a groove that is formed inside the carrier 210. Further, the sun gear 220 may be positioned on a center shaft of the two-speed transmission, and the planet gear portion 260 may be positioned around the sun gear 220.

The planet gear portion 260 may include a plurality of planet gears to receive the driving force from the sun gear 220 and then to provide an output to the carrier 210.

Further, the planet gear portion 260 may be arranged around the sun gear 220 with a predetermined specific structure. Here, the predetermined specific structure of the planet gear portion 260 may be a structure that implements the rotating direction of the output shaft of the two-speed transmission 200 in the same direction as the motor operation direction.

That is, the planet gear portion 260 may include at least one first planet gear 260 that is tooth-engaged with a gear train formed on the outer circumference of the sun gear 220, and is tooth-engaged with a gear train formed on the inner circumference of the ring gear 250.

The planet gear portion 260 may receive the driving force of the sun gear 220 through the structure that is tooth-engaged with the gear train formed on the outer circumference of the sun gear 220, and then may transfer the driving force that is provided from the sun gear 220 to the ring gear 250 through the structure that is tooth-engaged with the gear train formed on the inner circumference of the ring gear 250.

Further, the first one-way clutch 230 is configured to determine whether to transfer the driving force between the sun gear 220 and the carrier 210. When the sun gear 220 is rotated in a first rotating direction (e.g., clockwise direction), the first one-way clutch 230 is engaged with the sun gear 220 to be restrained by the sun gear 220.

That is, as the first one-way clutch 230 is restrained by the sun gear 220, it can directly transfer the driving force of the sun gear 220 to the carrier 210.

In this case, the carrier 210 directly receives the driving force of the sun gear 220 from the sun gear 220 through the first one-way clutch 230, and thus can be driven in a first reduction gear ratio.

If the first one-way clutch 230 operates as described above, the second one-way clutch 240 is configured not to operate. That is, since the second one-way clutch 240 does not operate, the planet gear portion 260 and the ring gear 250, which operate together by the driving of the sun gear 220, are idling.

In contrast, if the sun gear 220 is rotated in a second rotating direction (e.g., counterclockwise direction), the first one-way clutch 230 is not engaged with the sun gear 220 and thus is not restrained by the sun gear 220.

That is, a driving force transfer path between the sun gear 220 and the carrier 210 is blocked by the first one-way clutch 230, and the driving force of the sun gear 220 is transferred to the carrier 210 through the second one-way clutch 240.

In this case, the carrier 210 receives the driving force of the sun gear 220, which is gear-shifted through the sun gear 220, the planet gear portion 260, and the ring gear 250, through the second one-way clutch 240, and thus can be driven in a second reduction gear ratio.

If the second one-way clutch 240 operates as described above, the first one-way clutch 230 is configured not to operate. That is, by the operation of the second one-way clutch 240, the planet gear 260 and the ring gear 250, which operate together by the driving of the sun gear 220, transfer the gear-shifted driving force to the carrier 210 through the second one-way clutch 240. Here, since the planet gear portion 260 is provided with the at least one planet gear 260 that is tooth-engaged with the gear train formed on the outer circumference of the sun gear 220 and is tooth-engaged with the gear train formed on the inner circumference of the ring gear 250, the planet gear portion 260 serves to maintain the rotating direction (i.e., clockwise direction or counterclockwise direction) of the sun gear 220 and also to transfer the directivity thereof to the carrier 210.

Since the center shaft of the planet gear portion 260 is connected to one side of the carrier 210 through gear pins 270, it may be provided as a support structure that is connected to one side of the carrier 210.

On the other hand, in the device on which the two-speed transmission is mounted, a control module, which changes the rotating direction of the sun gear 220 that is provided in the two-speed transmission 200 to a predetermined specific pattern, may be included.

The control module can change the rotating direction of sun gear 220 to the predetermined specific pattern according to the load level of the motor that provides the external driving force to the sun gear 220.

For example, in the case where the load level of the motor is within a predetermined threshold range to indicate a normal speed of the motor operation, the motor may make the sun gear 220 be continuously rotated in the first rotating direction (e.g., clockwise direction) to maintain the output of the carrier 210 according to the restraint of the first one-way clutch.

AS another example, the load level of the motor may deviate from the predetermined threshold range. If the driving force of the motor is unable to reach the driving force in a normal operation state, the motor may make the sun gear 220 be rotated in the second rotating direction (e.g., counterclockwise direction) to shift the driving force to the output of the carrier 210 of which the reduction gear ratio is increased by the restraint of the second one-way clutch 240.

Further, if the load level of the motor reenters into the predetermined threshold range to indicate the normal speed of the motor operation, the control module may rotate the sun gear 220 again in the first rotating direction (e.g., clockwise direction).

Further, since the two-speed transmission according to the present invention can adjust the reduction gear ratio of the two-speed transmission according to the motor operation direction, and can implement the rotation direction of the output shaft of the two-speed transmission in the same direction as the motor operation direction or implement the rotation direction of the output shaft of the two-speed transmission in the predetermined specific direction regardless of the motor operation direction, it has sufficient possibility of marketing and business and thus can take effect realistically and clearly to achieve the industrial applicability.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A two-speed transmission comprising:
a sun gear configured to be rotated with an input shaft that transfers an external driving force;
a planet gear portion arranged in a predetermined specific structure around the sun gear to be tooth-engaged with the sun gear;
a ring gear having a gear train formed on an inner circumference thereof to be tooth-engaged with the planet gear portion;
a first one-way clutch configured to be engaged with the sun gear to be restrained by the sun gear if the sun gear is rotated in a first rotating direction;
a second one-way clutch configured to be engaged with the ring gear to be restrained by the ring gear if the sun gear is rotated in a second rotating direction; and
a carrier configured to receive a driving force from the sun gear by restraint of the first one-way clutch to be driven in a first reduction gear ratio or to receive a driving force that is transferred through the sun gear, the planet gear portion, and the ring gear by restraint of the second one-way clutch to be driven in a second reduction gear ratio, and to be rotated with an output shaft.

2. The two-speed transmission of claim 1, wherein the carrier is rotated in the same direction as the rotating direction of the sun gear, or is rotated in a predetermined specific direction regardless of the rotating direction of the sun gear.

3. The two-speed transmission of claim 2, wherein the planet gear portion comprises at least one planet gear that is tooth-engaged with a gear train formed on an outer circumference of the sun gear and is tooth-engaged with a gear train formed on an inner circumference of the ring gear when the carrier is rotated in the same direction as the rotating direction of the sun gear.

4. The two-speed transmission of claim 2, wherein the planet gear portion comprises:
at least one first planet gear configured to be tooth-engaged with a gear train formed on an outer circumference of the sun gear when the carrier is rotated in the predetermined specific direction regardless of the rotating direction of the sun gear; and
at least one second planet gear configured to be tooth-engaged with a gear train formed on an outer circumference of the first planet gear and to be tooth-engaged with a gear train formed on an inner circumference of the ring gear.

5. The two-speed transmission of claim 1, wherein the first reduction gear ratio is a reduction gear ratio that is lower than the second reduction gear ratio by a predetermined ratio.

6. The two-speed transmission of claim 1, wherein the second one-way clutch transfers a driving force that is transferred from the ring gear to the carrier when the second one-way clutch is engaged with the ring gear to be restrained by the ring gear.

7. The two-speed transmission of claim 1, wherein the rotating direction of the sun gear is changed to a predetermined specific pattern according to a load level that corresponds to the external driving force.
